(19) United States
(12) Patent Application Publication
(10) Pub. No.: US 2026/0352594 A1
(43) Pub. Date: Nov. 5, 2026

(54) ROAMING-AWARE FLOW INFORMATION SYNCHRONIZATION IN AN OVERLAY NETWORK

(71) Applicant: HEWLETT PACKARD ENTERPRISE DEVELOPMENT LP, Spring, TX (US)

(72) Inventors: Tathagata Nandy, Bangalore (IN); Venkatavaradhan Devarajan, Bangalore (IN); Renjith Vijayan, Bangalore (IN)

(21) Appl. No.: 19/251,989

(22) Filed: Jun. 27, 2025

(30) Foreign Application Priority Data
Apr. 30, 2025 (IN) 202541041733

(51) Int. Cl. H04L 45/64; H04L 43/028; H04L 45/76

(52) U.S. Cl. CPC H04L 45/64; H04L 43/028; H04L 45/76

(57) ABSTRACT

A network device in an overlay network can determine a role for a client device subsequent to detecting the client device via a local port. The network device can determine a roaming indicator for a client device indicating whether it is to roam to another network device. The network device can allocate a virtual local area network (VLAN) to the client device based on the role and the roaming indicator. The network device can determine flow information of a data flow from the client device. The flow information can indicate a category of an application generating the data flow. The network device can send, based on a messaging protocol, a message comprising the flow information to a broker of the messaging protocol. Subsequently, the flow information is to be distributed by the broker to a set of network devices subscribing to receive flow information associated with the VLAN.

### BACKGROUND

A network device, such as a switch, may support diverse protocols and services. For example, a network device can support an overlay network to provide virtual private networks (VPNs) using tunneling technologies and facilitate overlay routing for VPN traffic across these tunnels.

### BRIEF DESCRIPTION OF THE FIGURES

FIG. 1A illustrates an example of an overlay network supporting selective synchronization of flow information associated with a data flow, in accordance with an aspect of the present application.

FIG. 1B illustrates an example of an overlay network supporting selective synchronization of termination information associated with a data flow, in accordance with an aspect of the present application.

FIG. 2 illustrates an example of distributing flow information in an overlay network using a message passing protocol, in accordance with an aspect of the present application.

FIG. 3A presents a flowchart illustrating a process of a network device selectively synchronizing flow information associated with a data flow in an overlay network using a messaging protocol, in accordance with an aspect of the present application.

FIG. 3B presents a flowchart illustrating a process of a network device selectively synchronizing data flow termination information in an overlay network using a messaging protocol, in accordance with an aspect of the present application.

FIG. 4A presents a flowchart illustrating a process of a network device in an overlay network determining flow information associated with a data flow, in accordance with an aspect of the present application.

FIG. 4B presents a flowchart illustrating a process of a network device in an overlay network determining a roaming indicator for a client device, in accordance with an aspect of the present application.

FIG. 5 presents a flowchart illustrating a process of a network device forwarding a data flow from a roaming client device based on flow information synchronized in an overlay network, in accordance with an aspect of the present application.

FIG. 6 illustrates a computing system supporting selective synchronization of flow information associated with a data flow in an overlay network using a messaging protocol, in accordance with an aspect of the present application.

FIG. 7 illustrates a computer-readable medium (CRM) facilitating selective synchronization of flow information associated with a data flow in an overlay network using a messaging protocol, in accordance with an aspect of the present application.

In the figures, like reference numerals refer to the same figure elements.

### DETAILED DESCRIPTION

An overlay network is a virtual, logical network built on top of an existing physical network. In an overlay network, traffic forwarding is performed based on flows, which are sequences of packets of a common logical connection. Network devices use flow information to identify flows and enforce flow-specific policies. Aspects of the present disclosure address the technical challenge of insufficient flow information for policy enforcement when a client device roams to a new location in an overlay network, by proactively distributing relevant policy information to potential roaming target locations prior to the roaming event. To further optimize efficiently, a network device can delegate flow information distribution to a broker node via a subscription-based messaging protocol. The broker node then publishes the flow information to all potential target locations.

### Overlay Network Architecture

An overlay network is typically formed using overlay routing techniques to provide a VPN, which is the logical or “overlay” network, across a set of tunnels. Each tunnel serves as a link between two nodes in the overlay network. One example of an overlay network is the Ethernet VPN (EVPN), which is an overlay network built on top of a set of Virtual Extensible Local Area Network (VXLAN) tunnels. An overlay network or VPN can also be referred to as a distributed tunnel fabric. As noted above, communication between a pair of network devices within a fabric occurs through a dedicated tunnel. Correspondingly, each network device within the overlay network functions as a tunnel endpoint. This tunneling mechanism provides a secure and efficient way of transporting data across the network. In general, an overlay network creates a new layer where traffic can be programmatically directed through new virtual paths instead of specific underlying physical links. Overlay networks allow administrators to define and manage traffic flows, irrespective of the underlying physical infrastructure. The traffic flows, also referred to as “data flows,” can be defined in various, versatile ways and managed accordingly.

An overlay network is established when multiple network devices are interconnected through tunnels formed within an underlay network. In the underlay network, network devices are connected via one or more physical links and use a routing protocol, such as the Border Gateway Protocol (BGP), to establish routes over these physical links. The overlay network is often deployed based on a spine-and-leaf architecture, where leaf devices connect to spine devices. The spine devices maintain the tunnels as communication channels between leaf devices, which serve as edge devices for coupling with client or user devices. The spine devices can act as aggregation points, consolidating traffic from multiple leaf devices.

While leaf devices function as edge devices, they operate as tunnel endpoints in the overlay network. Meanwhile, both spine and leaf devices can participate in the routing protocol (e.g., BGP) in the underlay network. Correspondingly, the forwarding paths of the tunnels for the overlay network can originate and terminate at leaf devices, and can pass through spine devices in the underlay network. As a result, spine devices act as underlay devices through which overlay tunnels are established, and are usually not visible to devices operating only within the overlay network.

For example, when a leaf device receives a packet from a client device, the leaf device can encapsulate the packet with a tunnel encapsulation header and forward the encapsulated packet through a corresponding tunnel through the underlay network. The encapsulated packet is first sent to a spine device via an appropriate path in the underlay network. The spine device then forwards the packet toward its destination, which can be the other tunnel endpoint coupled to the destination, based on information in the encapsulation header, such as an outer Internet Protocol (IP) address. This process allows packets to traverse the underlay network while providing the effect of point-to-point connectivity between tunnel endpoints of the overlay network.

### Roaming of Client Device in Overlay Network

In a typical scenario, when a client device is coupled to a network device in an overlay network, the client device is authenticated based on its credentials, such as a password, smartcard, or dual authentication by a cellphone. If the authentication is associated with an enterprise, the credentials can also indicate the role or position of the user of the client device at that enterprise. With these credentials, the client device is mapped to a predefined role, which is associated with a set of privileges provided to the client device. For example, if the credentials of the client device indicate that the user is associated with the engineering department of the enterprise, the client device can be allocated a role of “engineering.” Subsequently, the resources accessible by the engineering department become available to the client device.

Once the client device is authenticated at the network device, the authentication is applicable to the entire overlay network. As a result, if the client device roams between network devices in the overlay network, the client device can continue sending and receiving data flows without reauthentication. To enforce application policies that dictate which client device can access specific applications or resources, the network device of the overlay network can inspect flow information (such as the category of the application generating the data flow, e.g., video streaming, social media, or web browsing) for a data flow from the client device, based on the headers and payloads of the packets in the data flow. The network device can then determine the application policy corresponding to the flow information and apply the application policy based on the client device's role. An application policy can indicate whether a client device with a given role is allowed to send or receive a specific type of data flow.

When a client device roams to a new network device, the client device typically continues sending and receiving its data flows via the new network device. However, the packets of the data flow at this point may not include the initial packets used to determine the flow information. Consequently, the classifier application at the new network device may not be able to obtain the flow information and enforce corresponding application policies in a timely manner. To support the enforcement of the application policies, the flow information may be shared among the network devices. Nonetheless, since data flows are typically transient, an individual client device may establish and terminate a significant number of data flows. As a result, due to the high-volume and transient nature of data flows, synchronizing flow information using traditional methods, such as EVPN route update messages, can be challenging because of their significant bandwidth and processing requirements.

To address this issue, a network device can determine whether a client device is roaming-enabled among the network devices of the overlay network. Once identified, the network device can share flow information of the roaming-enabled client devices with other network devices using a lightweight publisher-subscriber messaging protocol, such as Message Queuing Telemetry Transport (MQTT). The flow information can be derived from the initial packets of a data flow, such as TCP handshake packets, and can be synchronized with other network devices in the overlay network using the messaging protocol. This approach reduces bandwidth and processing overhead compared with traditional EVPN route update messages. The flow information can include details about the type of data flow and a flow identifier represented as a tuple [source Internet Protocol (IP) address, destination IP address, source protocol port, destination protocol port, transport protocol]. For example, if, in the header of a packet belonging to a particular data flow, the source IP address is X, the destination IP address is Y, the source protocol port is A, the destination protocol port is B, and the transport protocol is Transmission Control Protocol (TCP), then the flow identifier would be [X, Y, A, B, TCP]. Additionally, when TCP is used as the transport protocol, the respective protocol ports refer to TCP ports.

In typical implementations, each client role is mapped to a separate virtual local area network (VLAN). An overlay network can be configured with a set of non-roaming VLANs and a set of roaming VLANs, with each VLAN corresponding to a respective role. When a client device initially couples to a network device, the network device determines a roaming indicator for this client device to indicate whether the client device can roam in the overlay network. To determine the roaming indicator, the network device can identify the type of client device using a network scanning tool, such as NetFlow or Simple Network Management Protocol (SNMP). Based on this client device type, the network device then determines whether the client device is capable of roaming. For example, a hard-wired Internet of Things (IoT) device, such as a kitchen appliance, typically does not roam, whereas devices like laptops or tablets are more likely to roam.

If the client device type indicates that the client device is not capable of roaming, the network device can set the client device's roaming indicator to “non-roaming” and allocate the client device to a non-roaming VLAN corresponding to its role. Conversely, if the client device type indicates that the client device is capable of roaming, the network device can allocate the client device to a roaming VLAN based on its role. For client devices in a roaming VLAN, the network device can further evaluate whether a client device is likely to roam by analyzing its past behavior. For instance, a laptop that has not roamed in the past N days may be classified as a non-roaming device within a roaming VLAN, such as a laptop connected to a docking station. In this case, the network device can set the roaming indicator for this particular client device to “non-roaming.” However, if the client device resides in a roaming VLAN and exhibits behavior suggesting it is likely to roam, the network device can set the corresponding roaming indicator to “roaming.”

The network device can then distribute, to other network devices in the overlay network, flow information learned from the data flows of roaming-enabled client devices. The network device can selectively share the flow information with other network devices on the same roaming VLAN. To efficiently share the flow information, the network devices can deploy a publisher-subscriber messaging protocol, such as the MQTT protocol. The edge network devices (i.e., leaf devices) in communication with client devices can be the publishers and subscribers, while the aggregate network devices (i.e., spine devices) can be brokers (described in more details below) that distribute the published information. For example, if the MQTT protocol is deployed in the overlay network, the aggregate network devices can be MQTT brokers that receive the flow information published by the edge network devices and distribute the received flow information to the subscribers. It should be noted that the distribution of flow information is offloaded to the brokers, which are spine devices in the overlay network. This configuration makes the distribution more efficient and scalable, because the spine devices already function as “hub” nodes in the underlay network and are therefore provided with more resources designed for transporting a large amount of data to the leaf devices.

In general, any network device that supports a publisher-subscriber messaging protocol, such as the MQTT protocol, can be configured as a broker node to facilitate information distribution among publishers and subscribers within a group, such as network devices on a VLAN. A publisher is a network device that generates information intended for distribution to subscribers via the broker. For example, a publisher node on a given VLAN can transmit flow information to the broker using an MQTT publish message. In accordance with the MQTT protocol, the broker identifies the group's subscribers, such as other devices on the same VLAN and forwards the MQTT publish message to them. In this way, the broker can efficiently distribute the flow information to all members of the group.

Accordingly, a respective network device of the overlay network can subscribe to flow information associated with the VLANs configured on that network device. When a network device determines new flow information for a data flow received on a roaming VLAN, the network device can publish the flow information by including it in a message, such as an MQTT publish message, and sending the message to a broker. When the broker receives the MQTT publish message from the network device (i.e., the publisher), the broker can determine, based on the MQTT protocol, a set of network devices that have subscribed to flow information associated with the roaming VLAN. These subscribing network devices represent potential roaming targets for the client device. The broker subsequently forwards the message comprising the flow information to these network devices. Through this mechanism, other network devices in the same roaming VLAN can automatically receive the flow information from the broker based on their subscription. As a result, only network devices configured with that particular roaming VLAN receive the flow information. This selective distribution of flow information using brokers provides a seamless, efficient, and scalable way to accommodate roaming client devices.

When a network device receives the message from the broker, the receiving network device can obtain the flow information from the message and program the application policy associated with the data flow in its forwarding hardware, such as an application-specific integrated circuit (ASIC). This programming can involve generating an entry in a content-addressable memory (CAM) of the ASIC. The entry can specify whether the data flow is allowed to be forwarded based on the role of the client device initiating the data flow. Consequently, if the client device roams to this network device, the pre-programmed application policy can be readily applicable to the ongoing data flow.

Similarly, when a data flow terminates, a network device can also publish the corresponding termination information for that data flow to the broker coupled to the network device. The broker can then distribute the termination information to the other subscribing network devices. As a result, any network device that has programmed the application policy in its forwarding hardware can remove the corresponding entry from its forwarding hardware.

In this disclosure, the term “switch” is used in a generic sense, and it can refer to any standalone network device or fabric switch operating in any network layer. “Switch” should not be interpreted as limiting examples of the present disclosure to layer-2 networks. Any device that can forward traffic to another device can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present disclosure to a particular layer of a network protocol stack. “Packet” can be replaced by other terminologies referring to a group of bits, such as “message,” “frame,” “cell,” “datagram,” or “transaction.” Furthermore, the term “port” can refer to an endpoint of a link that can receive or transmit data. “Port” can also refer to the hardware, software, and/or firmware logic that can facilitate the operations of that port.

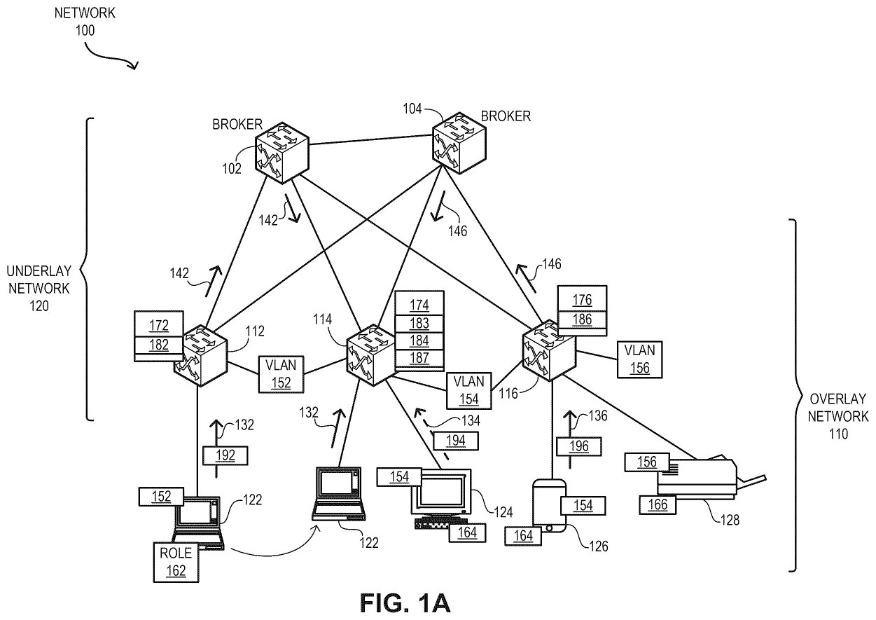

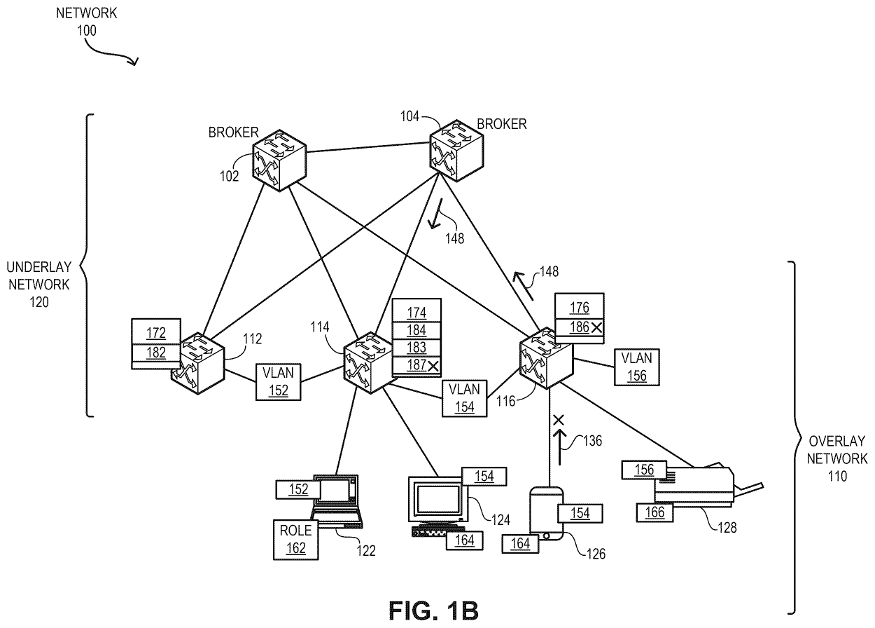

FIG. 1A illustrates an example of an overlay network supporting selective synchronization of flow information associated with a data flow, in accordance with an aspect of the present application. A network 100 can include various network devices, such as switches, and can include heterogeneous network connections, such as layer-2 and layer-3 hops and tunnels. In some examples, network 100 can be an Ethernet network, an InfiniBand network, or another type of network, utilizing corresponding communication protocols such as IP, Fibre Channel over Ethernet (FCoE), or others. In this example, network 100 includes several network devices, such as network devices 102, 104, 112, 114, and 116. Client devices 126 and 128 can be coupled to network device 116, and client devices 122 and 124 can be coupled to network devices 112 and 114, respectively.

Each network device in network 100 is assigned a unique media access control (MAC) address and an IP address, and is equipped with at least one processing resource. These processing resources may include, but are not limited to, processor cores, graphics processing units (GPUs), and tensor processing units (TPUs). The network device can also include at least one non-transitory computer-readable medium storing instructions that, when executed by the processing resource, cause the processing resource to perform one or more operations. Additionally, the network device can include forwarding hardware, such as an ASIC, which typically includes a CAM. This hardware configuration allows the network device to efficiently manage and forward network traffic.

Network devices 112, 114, and 116 can be part of overlay network 110, which functions as a tunnel fabric. These network devices can be interconnected via tunnels, with tunnel encapsulation initiated and terminated at these network devices within the overlay network. In this example, client devices 122, 124, 126, and 128 are coupled to and communicate via network devices of overlay network 110. In general, when a user device is coupled to an overlay network, the user device becomes part of the overlay network.

The network devices in overlay network 110 may form a mesh topology, with the links being tunnels, which can be established using various tunneling protocols such as VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). A VPN, such as an EVPN, can be deployed in overlay network 110. To send a packet through a tunnel, a network device acting as one tunnel endpoint encapsulates the packet with a tunnel-specific encapsulation header before forwarding the packet. The receiving network device, functioning as the other tunnel endpoint, then removes the encapsulation header to retrieve the original packet. This encapsulation and decapsulation process allows transmission of overlay data flows through the tunnels.

The tunnels in overlay network 110 are established over an underlay network 120, which is a physical network with physical links. Each network device in overlay network 110 is also part of underlay network 120, and network devices operating as tunnel endpoints function in both networks simultaneously. In underlay network 120, pairs of network devices can form peer relationships with respect to the underlay routing protocol running on these devices (such as BGP). This allows each network device to use the underlay routing protocol to establish routes for packet forwarding in underlay network 120. Consequently, the encapsulated packets from overlay network 110 are forwarded through these established routes in underlay network 120 based on the encapsulation headers.

In some examples, network 100 can be a spine and leaf network wherein network devices 112, 114, and 116 can be leaf devices, and network devices 102 and 104 can be spine devices. Here, leaf devices 112, 114, and 116 can be in overlay network 110 as tunnel endpoints. Spine devices 102 and 104 can be part of underlay network 120 via which the tunnels of overlay network 110 are established. Under such a spine-and-leaf architecture, spine devices 102 and 104 can operate as aggregation network devices that can aggregate traffic from leaf devices 112, 114, and 116, which can be edge network devices coupled to client devices.

When client device 122 is coupled to network device 112, network device 112 may detect the presence client device 122 by learning client device 122's MAC address from the initial packets received at a local port of network device 112. Once detected, client device 122 undergoes authentication based on its user's credentials, such as a username and password. This authentication is valid across the entire overlay network 110. Consequently, if client device 122 roams between network devices in overlay network 110, client device 122 can resume sending and receiving data flows without reauthentication. Upon the initial authentication, client device 122 is assigned to a role 162 based on its credentials. Here, role 162 can represent a set of privileges provided to client device 122 from overlay network 110. Similarly, other client devices, such as 124 and 126, can be associated with role 164, while client device 128 may be assigned role 166.

To enforce application policies that dictate which client device can access specific applications or resources, network device 112 can determine flow information 192 from data flow 132, which originates from client device 122. Flow information 192 can include the application category of data flow 132 (for example a video stream). Flow information 192 can also include a flow identifier represented by a tuple comprising the IP address of client device 122, the destination IP address of data flow 132, the protocol ports of data flow 132, and the transport protocol. Network device 132 can then apply the corresponding application policy, which can dictate whether a device with role 162 is allowed to send or receive data flow 132. For example, if data flow 132 includes video streaming, network device 112 can determine whether video streaming data is allowed for client device 122 based on its role 162 and the video streaming policy associated with role 162.

Network device 112 typically utilizes a classifier application to analyze the initial packets of data flow 132, such as TCP handshake packets, to determine flow information 192. Examples of the classifier application can include, but are not limited to, Internet Protocol Flow Information Export (IPFIX) and Application Recognition and Control (ARC). The classifier application may perform a deep packet inspection (DPI) on these initial packets to determine flow information 192, such as the category of the application generating data flow 132. Performing DPI may involve examining the inner fields of packets within data flow 132. These inner fields extend beyond those found in the outer headers and are not typically used for forwarding decisions. For example, to perform DPI, network device 112 can inspect the inner header fields, such as IP header fields within an Ethernet packet, to determine flow information 192. If client device 122 roams from client device 112 to network device 114, client device 122 can resume transmission and receiving of data flow 132 through network device 114. Subsequent to the roaming of client device 122, the packets of data flow 132 may not include the initial packets used to determine flow information 192. As a result, the classifier application on network device 114 may be unable to timely retrieve flow information 192 and enforce the corresponding application policy.

To address this issue, upon determining role 162 of client device 122, network device 112 can determine a roaming indicator which indicates whether client device 122 is roaming-enabled. Note that a roaming indicator can be in the form of any data structure, and can be as simple as a one-bit value where “1” indicates “roaming-enabled” and “0” indicates “non-roaming.” If client device 122 is roaming enabled, network device 112 can publish flow information 192 to other network devices in the same roaming VLAN using a publisher-subscriber messaging protocol, such as MQTT. As mentioned earlier, overlay network 110 can be configured with roaming VLANs 152 and 154, as well as non-roaming VLAN 156, with each VLAN corresponding to a specific role. For instance, VLAN 152 can be configured on network devices 112 and 114, VLAN 154 on network devices 114 and 116, and VLAN 156 on network device 116. As described above, when client device 122 initially couples to network device 112, network device 112 determines role 162 for client device 122. Network device 112 then determines the roaming indicator for client device 122, which indicates whether client device 122 can roam to another network device in overlay network 110. To determine this roaming indicator, network device 112 identifies a type for client device 122 and determines whether this type supports roaming. Similarly, network device 114 identifies the type of client device 124, while network device 116 determines the types of client devices 126 and 128. In the example in FIG. 1A, client devices 122, 124, and 126 are computing devices and are therefore capable of roaming. In contrast, client device 128 is a printer and is not roaming-enabled.

Because client device 128's type indicates that it is not capable of roaming, network device 116 determines the roaming indicator to be “non-roaming” for client device 128 and allocates non-roaming VLAN 156, which corresponds to client device 128's role 166, to client device 128. In contrast, client devices 122, 124, and 126 are identified as roaming-enabled based on their type. As a result, network device 112 allocates roaming VLAN 152, which corresponds role 162, to client device 122. Similarly, network device 114 allocates roaming VLAN 154, which corresponds to role 164, to client device 124; and network device 116 allocates roaming VLAN 154 to client device 126, which also has role 164.

In one aspect, network device 112 can further evaluate whether client device 122 is likely to roam by analyzing its past behavior. If client device 122 has roamed within a predetermined timeframe (e.g., in the past N days), network device 112 determines a roaming indicator of “roaming” for client device 122. Similarly, network device 116 can evaluate the likelihood of roaming for client device 126 based on its past behavior. If client device 126 has roamed within the same timeframe, network device 116 sets the roaming indicator for client device 126 to “roaming.” Conversely, if client device 124 has not roamed in the predetermined timeframe, client device 124 may be classified as a non-roaming device in roaming VLAN 154. In this case, network device 114 sets the roaming indicator of client device 124 to “non-roaming.” In other words, a roaming-enabled client device can be allocated to a roaming VLAN, and still has a “non-roaming” indicator, if this client device has not roamed in a pre-determined period. Accordingly, network device 114 may not publish flow information of data flows originating from client device 124 because it has a “non-roaming” indicator.

To enforce application policies in overlay network 110, network device 112 uses a classifier application to determine flow information 192 from data flow 132. Network device 112 can then determine a corresponding application policy for data flow 132 based on flow information 192 and program the application policy in its forwarding hardware 172. This programming can involve generating an entry 182 in a CAM in forwarding hardware 172. The application policy in entry 182 can specify whether network device 112 is allowed to forward data flow 132 originating from client device 122 with its role 162. If forwarding is allowed, network device 112 can forward data flow 132 through overlay network 110. On the other hand, if forwarding is not allowed, network device 112 can drop data flow 132.

Since client device 122 is a part of roaming VLAN 152 and has a roaming indicator as “roaming,” network device 112 can share flow information 192 with other network devices on VLAN 152. For efficient distribution of this flow information, in one aspect, network 100 can employ a publisher-subscriber messaging protocol, in which broker nodes are used to broadcast the messages to subscribers, and publishers of messages only need to send the messages to the broker nodes. In the example of FIG. 1A, edge network devices 112, 114, and 116 can function as both publishers and subscribers, while aggregate network devices 102 and 104 serve as brokers responsible for distributing the flow information provided by the publishers. It should be noted that network 100 can include a plurality of brokers, each associated with a subset of subscribers in overlay network 110. In this example, network device 102 is designated as the broker for information associated with VLAN 152, while network device 104 is designated as the broker for information associated with VLAN 154.

Subsequent to allocating VLAN 152 to client device 122 based on its role 162 and determining the roaming indicator, network device 112 can send, based on the MQTT protocol, a message 142 comprising flow information 192 to network device 102 functioning as the MQTT broker. To do so, network device 112 can generate message 142, which indicates that flow information 192 is associated with VLAN 152. Furthermore, network device 112 can determine that network device 102 is the MQTT broker for VLAN 152, based on a broker-to-VLAN mapping table locally stored in network device 112. Subsequently, network device 112 can forward message 142 to network device 102. If message 142 is an MQTT publish message, the MQTT topic field in message 142 can be used to indicate that message 142 is associated with VLAN 152.

Network devices on VLAN 152 can subscribe to flow information published on the same VLAN. When network device 102 receives message 142, network device 102 can determine from the MQTT topic field in message 142 that flow information 192 is intended for network devices subscribing to information associated with VLAN 152. Network device 102 can identify network device 114 as a corresponding subscriber based on a locally maintained list of subscribers for each VLAN. Network device 102 can then forward message 142, which comprises flow information 192, to network device 114. This process allows network device 114 to receive flow information 192 via network device 102, since both client device 122 and network device 114 are part of VLAN 152. Consequently, only the potential roaming targets for client device 122 receive flow information 192. Upon receiving message 142 from network device 102, network device 114 obtains flow information 192 and uses it to generate an entry 183 that specifies the application policy for data flow 132 in its forwarding hardware 174.

If client device 122 roams to network device 114, entry 183 associated with the application policy for ongoing data flow 132 is already programmed in forwarding hardware 174. As a result, when a packet of data flow 132 is received at network device 114, the application policy in entry 183 can readily be applied to the packet. Accordingly, if the application policy allows data flow 132 associated with role 162 to be forwarded, network device 114 can forward the packet across overlay network 110. Conversely, if the application policy does not allow data flow 132 to be forwarded, network device 114 can drop the packet. In this way, overlay network 110 can support efficient synchronization of flow information, and facilitate seamless enforcement of application policies with roaming client devices.

Network device 114 can also use the classifier application to determine flow information 194 associated with data flow 134, which originates from client device 124. Using flow information 194, network device 114 can generate an entry 184 in its forwarding hardware 174, specifying the application policy for data flow 134. Entry 184 may indicate whether network device 114 is allowed to forward data flow 134 based on role 164. Even though client device 124 is a part of roaming VLAN 154, network device 114 can determine that the roaming indicator for client device 124 designates it as “non-roaming” due to a lack of roaming activity. As a result, network device 114 refrains from sharing flow information 194 with other network devices in overlay network 110.

Similarly, network device 116 can use the classifier application to determine flow information 196 associated with data flow 136, originating from client device 126. Based on flow information 196, network device 116 can generate an entry 186 in its forwarding hardware 176, specifying the application policy for data flow 136. Entry 186 may indicate whether network device 116 is allowed to forward data flow 136 based on role 164. Since client device 126 is a part of roaming VLAN 154 and the roaming indicator for client device 124 designates it as “roaming,” network device 116 can selectively share flow information 196 with other network devices on VLAN 154. To publish flow information 196, network device 116 generates message 146, which can be an MQTT publish message, and sends message 146 to network device 104, which functions as the MQTT broker for VLAN 154.

Network devices on VLAN 154 can subscribe to information published in the same VLAN. When network device 104 receives message 146, network device 104 can determine from the MQTT topic field in message 146 that flow information 196 is intended for network devices subscribing to information associated with VLAN 154. Network device 104 identifies the network devices, such as network device 114, which subscribe to information associated with VLAN 154. Network device 104, functioning as the MQTT broker, then distributes message 146, comprising flow information 196, to network device 114. In this way, network device 114 receives flow information 196 via network device 104 because both client device 126 and network device 114 are part of roaming VLAN 154. Consequently, only the potential roaming targets for client device 126 receive flow information 196. Upon receiving message 146 from network device 104, network device 114 obtains flow information 196 and generates an entry 187 in its forwarding hardware 174, specifying the application policy for data flow 136.

FIG. 1B illustrates an example of an overlay network supporting selective synchronization of termination information associated with a data flow, in accordance with an aspect of the present application. Typically, data flows are transient in nature and can terminate after a period. For example, data flow 136 can terminate (denoted with a cross) when client device 126 stops sending packets of data flow 136. When network device 116 does not receive data flow 136 for a predetermined timeout period, network device 116 determines that data flow 136 is terminated. Network device 116 can then remove entry 186 associated with data flow 136 from forwarding hardware 176. Since client device 126 is on a roaming VLAN 154, and the roaming indicator for client device 126 indicates “roaming,” network device 116 can then publish the termination information associated with data flow 136. The termination information can include the flow identifier of data flow 136 and an indicator (e.g., a predetermined value) indicating the termination of data flow 136.

To publish the termination information, network device 116 can generate a message 148, which can be an MQTT publish message, and send message 148 to network device 104 serving as an MQTT broker. When network device 104 receives message 148, network device 104 can determine network devices that subscribe to flow information for VLAN 154, such as network device 114. Network device 104 subsequently forwards message 148 comprising the termination information to network device 114. Network device 114 can, in turn, determine that data flow 136 is terminated based on the indicator in message 148. Network device 114 can then remove entry 187 associated with data flow 136 from forwarding hardware 174. In this way, when a data flow terminates, network devices on VLAN 154 remove entries associated with data flow 136 from their respective forwarding hardware, thereby freeing hardware resources for subsequent usage.

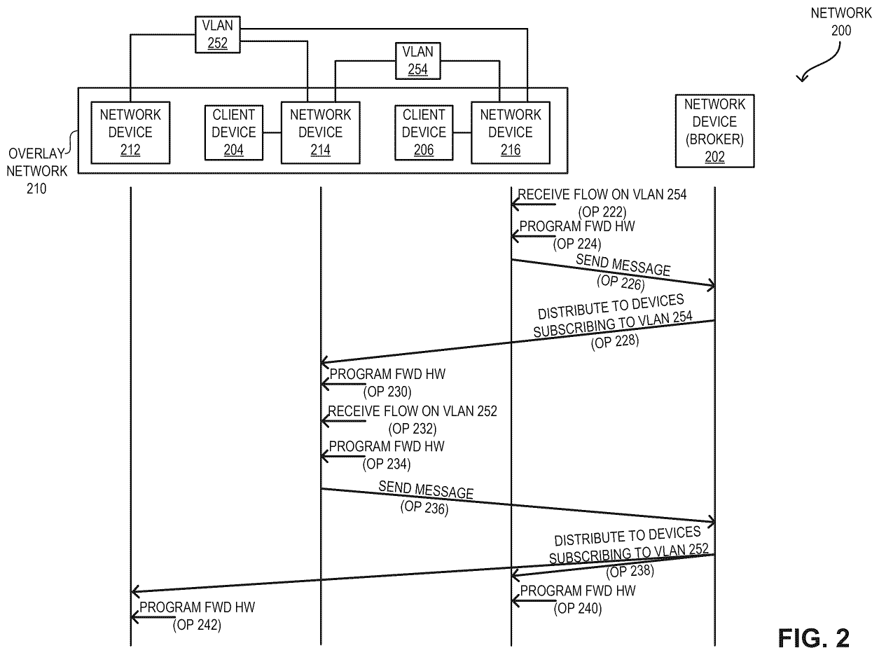

FIG. 2 illustrates an example of distributing flow information in an overlay network using a message passing protocol, in accordance with an aspect of the present application. A network 200 comprises several network devices, including network devices 202, 212, 214, and 216. Network devices 212, 214, and 216 can be part of an overlay network 210 and can be edge network devices that couple client devices (not shown in FIG. 2), whereas network device 202 can be an aggregate network device that aggregates traffic from network devices 212, 214, and 216. To efficiently share the flow information, network devices 202, 212, 214, and 216 can deploy a publisher-subscriber messaging protocol, such as the MQTT protocol. Edge network devices 212, 214, and 216 can be the publishers and subscribers, and aggregate network device 202 can be the broker that distributes the published information. If the MQTT protocol is used, network device 202 can be the MQTT broker that receives the flow information published by network devices 212, 214, and 216 and distributes the flow information to the subscribers.

Overlay network 210 can be configured with roaming VLANs 252 and 254, with each VLAN corresponding to a role supported by overlay network 210. Here, VLAN 252 can be configured on network devices 212, 214, and 216, and VLAN 254 can be configured on network devices 214 and 216. Network devices on VLAN 252 can subscribe to flow information published on VLAN 252. Therefore, if network device 216 publishes a message with flow information associated with VLAN 252, network device 202 can distribute that message to network devices 212 and 214. Similarly, network devices on VLAN 254 can subscribe to flow information published on VLAN 254. Therefore, if network device 216 publishes a message associated with VLAN 254, network device 202 can distribute that message to network device 214 and may not send it to network device 212 since VLAN 254 is not configured on network device 212.

Network devices 214 and 216 can be coupled to client devices 204 and 206, respectively. Upon detecting client device 204, network device 214 can determine a role for client device 204. Network device 214 can determine a roaming indicator for client device 204, indicating that client device 204 is a roaming-enabled device. Subsequently, network device 214 allocates VLAN 252 to client device 204 based on its role and the determined roaming indicator. Similarly, when network device 216 detects client device 206, network device 216 can determine a role and a roaming indicator indicating “roaming” for client device 206. Based on client device 206's role and roaming indicator, network device 216 allocates VLAN 254 to client device 206.

During operation, network device 216 can receive a data flow on VLAN 254 from client device 206 (operation 222), which can involve network device 216 receiving a set of packets of the data flow at a local port of network device 216. Network device 216 can determine the flow information of the data flow, which indicates a category of the data flow, using a classifier application on the initial packets. Based on the role of client device 206, network device 216 can further determine the applicable application policy. In one aspect, network device 216 can maintain a repository, which stores application policies for different roles. In a further aspect, network device 216 can contact a remote entity, such as an application policy server, to obtain the policy corresponding to the identified role. To apply the application policy on the data flow, network device 216 can program the application policy in its forwarding hardware (operation 224), which can involve generating an entry in a CAM in the forwarding hardware of network device 216. Since client device 206 is a roaming-enabled device, as indicated by its roaming indicator, network device 216 is to publish the flow information. Hence, network device 216 can generate a message, which can be an MQTT publish message, and send the message to network device 202 serving as an MQTT broker (operation 226). In one aspect, the MQTT topic field of the message can indicate that the message is associated with VLAN 254.

After receiving the message, network device 202 can determine, from the MQTT topic field in the message, that the flow information is published for network devices that subscribe to flow information published on VLAN 254. Network device 202 can then distribute the message to the subscribers on VLAN 254 (operation 228). Since network device 214 is on VLAN 254, network device 214 is a potential roaming target for any client device on VLAN 254, and therefore, subscribes to information published on VLAN 254. Accordingly, network device 202 can forward the message to network device 214. Upon receiving the message, network device 214 can obtain the flow information from the message and program the corresponding application policy for the data flow from client device 206 in its forwarding hardware (operation 230).

In addition, network device 214 can receive a data flow on VLAN 252 from client device 204 (operation 232). Network device 214 can determine the flow information of the data flow using a classifier application. Based on the role of client device 204, network device 214 can then program a corresponding application policy associated with the data flow in its forwarding hardware (operation 234). To do so, network device 214 can generate an entry in a CAM in its forwarding hardware. Since client device 204 is a roaming-enabled device, as indicated in its roaming indicator, network device 214 can publish the flow information by generating and sending an MQTT message to network device 202 (i.e., the broker) (operation 236). The MQTT topic field of the message can indicate that the message is associated with VLAN 252.

Upon receiving the message, network device 202 can determine, from the topic field in the message, that the flow information is published for VLAN 252. Network device 202 can then distribute the message to devices subscribing to flow information associated with VLAN 252 (operation 238). Since network devices 212 and 214 are on VLAN 252, they both subscribe to flow information published on VLAN 252. Correspondingly, network device 202 can forward the message to network devices 212 and 214. Upon receiving the message, network device 216 can obtain the flow information and program the application policy for the data flow from client device 204 in its forwarding hardware accordingly (operation 240). Similarly, upon receiving the message, network device 212 can program the same application policy for the data flow from client device 204 in its forwarding hardware (operation 242). In this way, each network device in overlay network 210 can efficiently share the flow information of a data flow received over a roaming VLAN to potential roaming targets.

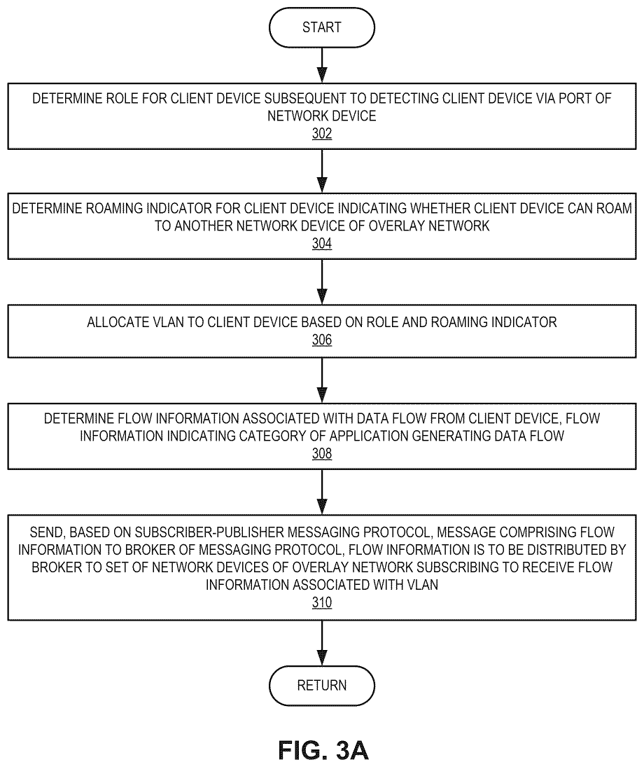

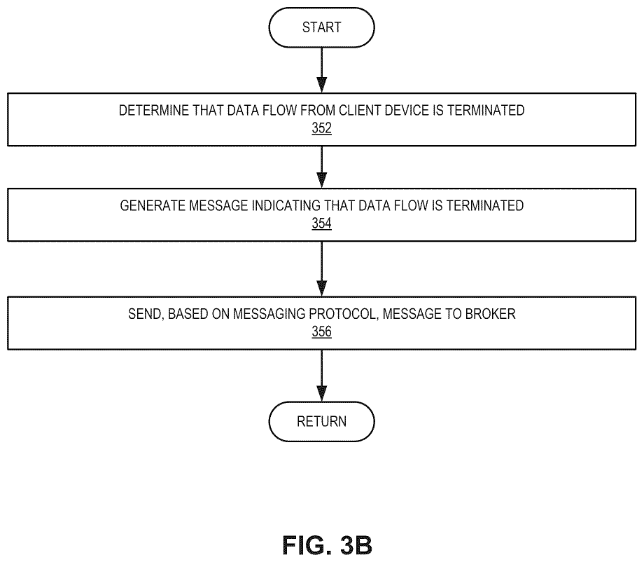

FIG. 3A presents a flowchart illustrating a process of a network device selectively synchronizing flow information associated with a data flow in an overlay network using a messaging protocol, in accordance with an aspect of the present application. During operation, the network device can determine a role for a client device subsequent to detecting the client device via a port of the network device (operation 302). When the client device is detected via the port, the client device is authenticated based on the credentials of the user of the client device, such as the username and password of the user. Based on the credentials, the client device becomes associated with the role, which is associated with a set of privileges provided to the client device from the overlay network.

The network device can then determine a roaming indicator for the client device, which indicates whether the client device can roam to another network device of the overlay network (operation 304). The network device can determine whether the client device is capable of roaming based on the type of the client device. If the client device is capable of roaming, the network device can further evaluate whether the client device is likely to roam by analyzing its past behavior. If the client device is capable of roaming and exhibits behavior suggesting it is likely to roam, the network device sets the roaming indicator to “roaming.” Otherwise, the network device sets the roaming indicator to “non-roaming.”

The network device can then allocate a VLAN to the client device based on the role and the roaming indicator (operation 306). If the client device is not capable of roaming, the network device can allocate the client device to a non-roaming VLAN corresponding to its role. Conversely, if the type indicates that the client device is capable of roaming, the network device can allocate the client device to a roaming VLAN based on its role. The network device can then determine the flow information associated with a data flow from the client device (operation 308). Here, the flow information indicates a category of the application generating the data flow, such as video streaming, social media, or web browsing. In one aspect, the network device can use a classifier application on the initial packets, such as those involved in a TCP handshake, of the data flow. This process allows the network device to determine the flow information associated with the identified role.

Subsequently, the network device can send, based on a publisher-subscriber messaging protocol, a first message comprising the flow information to a broker of the messaging protocol (operation 310). Here, the flow information is to be distributed by the broker to a set of network devices of the overlay network subscribing to receive flow information associated with the VLAN. The network devices on the VLAN can subscribe to information associated with the VLAN. These subscribing network devices represent potential roaming targets for the client device. The broker subsequently forwards the message comprising the flow information to these network devices. In the example in FIG. 1A, network device 112 determines a role 162 for client device 122 and allocates a roaming VLAN 152 for client device 122 based on its capability of roaming and role 162. Network device 112 can then determine flow information 192 from data flow 132 originating from client device 122. Subsequently, network device 112 can send a message 142 comprising flow information 192 to network device 102 functioning as a broker.

FIG. 3B presents a flowchart illustrating a process of a network device selectively synchronizing data flow termination information in an overlay network using a messaging protocol, in accordance with an aspect of the present application. Here, the network device performing the process described in FIG. 3B can correspond to the network device performing the process described in FIG. 3A. During operation, the network device can determine that a data flow from a client device is terminated (operation 352). The data flow can terminate when the client device stops sending packets of the data flow. When the network device does not receive the data flow for a predetermined timeout period, the network device determines that the data flow is terminated.

The network device can then generate a message indicating that the data flow is terminated (operation 354). The message can be an MQTT publish message and comprise the termination information associated with the data flow. The termination information can include the flow identifier of the data flow and an indicator indicating the termination of the data flow. The network device can then send, based on the messaging protocol, the second message to the broker (operation 356). The termination information is to be distributed by the broker to a set of network devices subscribing to receive information associated with the VLAN. Correspondingly, in the example in FIG. 1B, when network device 116 does not receive data flow 136 for a predetermined timeout period, network device 116 determines that data flow 136 is terminated. Network device 116 can then publish the termination information associated with data flow 136 by generating a message 148, which can be an MQTT publish message, and sending message 148 to network device 104 serving as an MQTT broker.

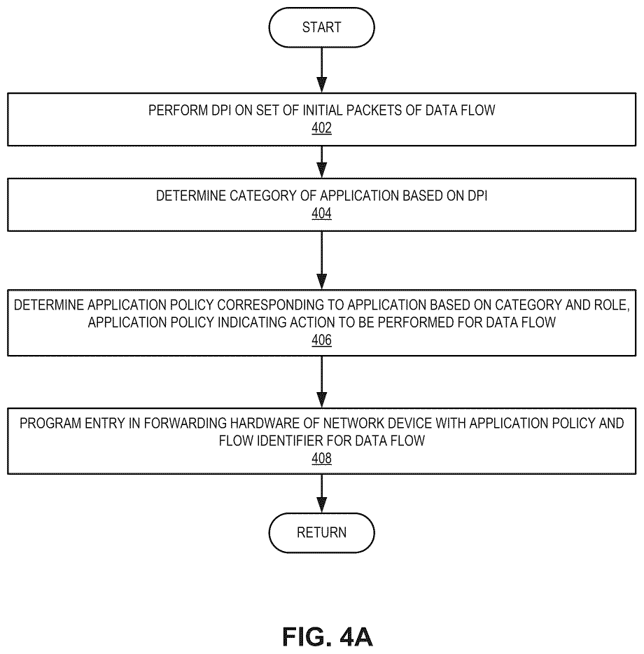

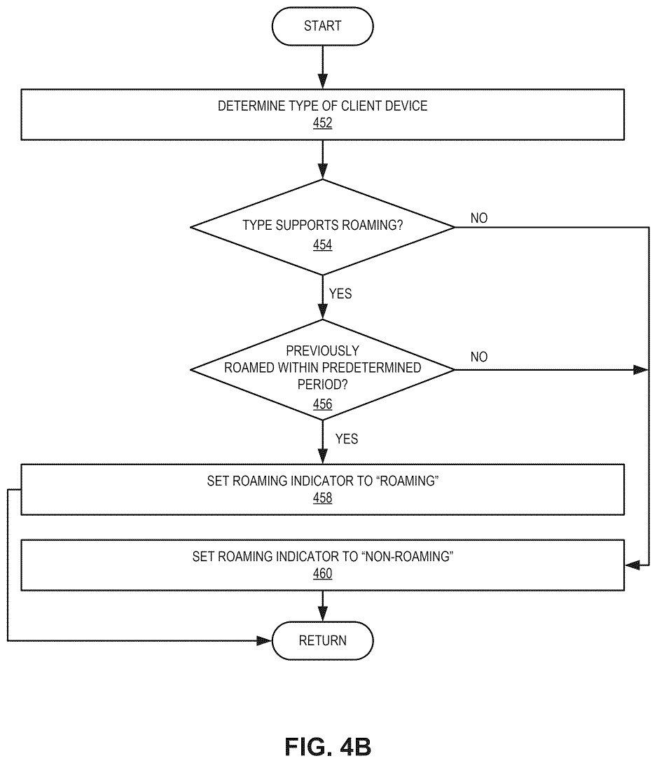

FIG. 4A presents a flowchart illustrating a process of a network device in an overlay network determining flow information associated with a data flow, in accordance with an aspect of the present application. Here, the network device performing the process described in FIG. 4A can correspond to the network device performing the process described in FIG. 3A. During operation, the network device can perform DPI on the initial packets of a data flow (operation 402). The network device can use a classifier application on the initial packets, such as those involved in a TCP handshake, of the data flow to determine the flow information. The network device can then determine the category of the application, which generates the data flow, based on the DPI (operation 404). Typically, the initial packets of a data flow include information indicating the type of application generating these packets. For example, if the application is a video streaming application, the initial packets can indicate that the data flow is a video streaming data flow. Therefore, by performing DPI on these initial packets, the network device can determine the category of the associated application.

The network device can determine the application policy corresponding to the application based on the category of the application and the role of the client device (operation 406). The application policy can indicate an action to be performed for the data flow. The application policy can further specify whether the network device is allowed to forward the data flow associated with the role. If the network device is allowed to forward the data flow, the network device can forward the data flow via the overlay network. On the other hand, if the network device is not allowed to forward the data flow, the network device can drop the data flow without forwarding it.

In addition, the network device can program an entry in its forwarding hardware of the network device with the application policy and a flow identifier for the data flow (operation 408). The flow identifier can be represented as a tuple [source IP address, destination IP address, source protocol port, destination protocol port, transport protocol]. The flow identifier can uniquely identify each packet of the data flow, since this tuple is present in each packet's header. Based on the flow identifier, the packet can match the entry, which allows the network device to identify and enforce the application policy. Correspondingly, in the example in FIG. 1A, network device 112 can determine flow information 192 of data flow 132 using a classifier application performing DPI. Network device 112 can then program the application policy in its forwarding hardware 172 by generating an entry 182 in a CAM in forwarding hardware 172. The application policy in entry 182 can specify whether network device 112 is allowed to forward data flow 132 from role 162.

FIG. 4B presents a flowchart illustrating a process of a network device in an overlay network determining a roaming indicator for a client device, in accordance with an aspect of the present application. Here, the network device performing the process described in FIG. 4B can correspond to the network device performing the process described in FIG. 3A. During operation, the network device can determine a type of a client device (operation 452). To do so, the network device can use a network scanning tool, such as NetFlow or SNMP. For example, the network device can determine whether the client device is an IoT device, a network appliance (e.g., a firewall), a service device (e.g., a printer), a computing device (e.g., a laptop or tablet), or a mobile device.

The network device can then determine whether the device type supports roaming (operation 454). For example, an IoT device typically does not roam, whereas devices like laptops or tablets are more likely to roam. The network device can further evaluate whether the client device is likely to roam by analyzing its past behavior. Specifically, the network device can determine whether the client device has previously roamed within a predetermined period (e.g., roamed in the past N days) (operation 456). For example, a laptop that has not roamed in the past N days may be classified as a non-roaming device. In contrast, if the laptop has roamed in the past N days, the laptop is likely to roam again.

Hence, if the device type supports roaming, and the client device has previously roamed within the predetermined period, the client device is likely to roam again. Correspondingly, the network device can set the roaming indicator for the client device to “roaming” (operation 458). Conversely, if the device type does not support roaming, the client device cannot roam to another network device of the overlay network. Furthermore, even if the device type supports roaming, the client device may not roam if it has not roamed within a predetermined period. For either scenario (operation 454 or 456), the network device can set the roaming indicator for the client device to “non-roaming” (operation 460). Referring to the example in FIG. 1A, since client device 128's type indicates that it is not capable of roaming, network device 116 can set the roaming indicator of client device 128 to “non-roaming.” Conversely, since the type of client devices 124 and 126 indicates that they are capable of roaming, network device 114 can determine whether these client devices have previously roamed in a predetermined number of days. Based on their previous history of roaming, network device 114 can set the roaming indicator for client device 124 to “roaming” and the roaming indicator of client device 126 to “non-roaming.”

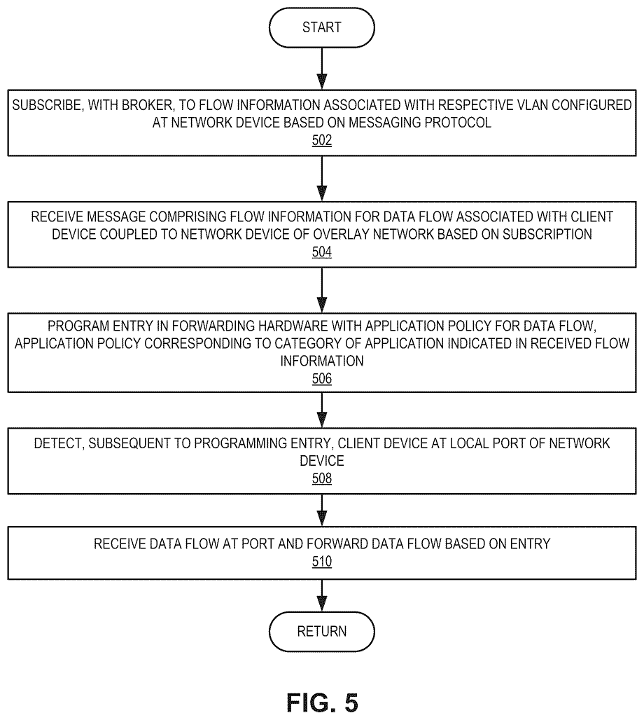

FIG. 5 presents a flowchart illustrating a process of a network device forwarding a data flow from a roaming client device based on flow information synchronized in an overlay network, in accordance with an aspect of the present application. Here, the network device performing the process described in FIG. 4B can correspond to the network device performing the process described in FIG. 3A. During operation, the network device can subscribe, with the broker, to flow information associated with a respective VLAN configured at the network device based on the messaging protocol (operation 502). The network device is also a potential roaming target for a respective roaming-enabled client device on each VLAN configured at the network device. Therefore, by subscribing to information associated with each such VLAN, the network device can receive flow information published on any of these VLANs.

Accordingly, the network device can receive a message comprising the flow information for a data flow associated with a client device coupled to a second network device based on the subscription (operation 504). The client device can be on a VLAN that is also configured on the network device. As a result, when the second network device publishes the flow information for the data flow to the broker based on the messaging protocol, the broker can forward that flow information to the network device via the message. The network device can then program an entry in its forwarding hardware with an application policy for the data flow (operation 506). The application policy can specify whether the network device is allowed to forward the data flow.

Because the network device is a potential roaming target, the client device may roam to the network device. If such roaming occurs, the network device may detect, subsequent to programming the entry, the client device at a local port of the network device (operation 508). The network device can detect the client device when the network device learns the MAC address of the client device from the initial packet received at the port. If the data flow is ongoing, the client device can start sending the data flow to the network device. Hence, the network device can receive the data flow at the local port and forward the flow based on the application-policy entry (operation 510). Since the entry is already programmed in the forwarding hardware, the network device can readily apply the application policy to the data flow. Referring to the example in FIG. 1A, client device 114 can generate entry 183 in forwarding hardware 174 based on message 142 from network device 102. When client device 122 roams to network device 114, network device 114 can readily apply the application policy on data flow 132 based on entry 183.

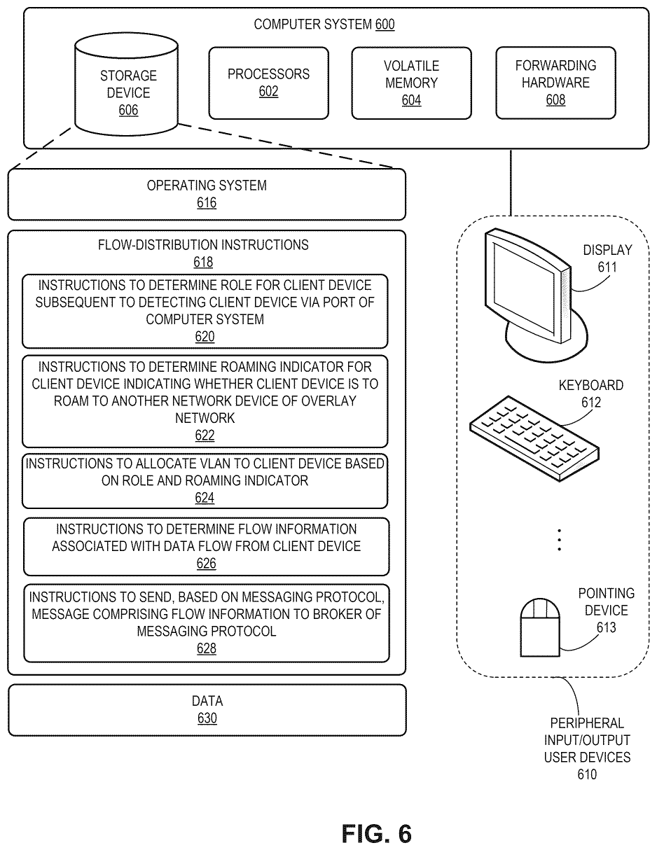

FIG. 6 illustrates a computing system supporting selective synchronization of flow information associated with a data flow in an overlay network using a messaging protocol, in accordance with an aspect of the present application. In this example, computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a CAM. Storage device 606 includes a non-transitory computer-readable storage medium and stores an operating system 616, flow-distribution instructions 618, and data 630. Computer system 600 may include fewer or more entities or instructions than those shown in FIG. 6. Computer system 600 can correspond to network device 112, 114, or 116 of FIG. 1A, or network device 212, 214, or 216 of FIG. 2.

Flow-distribution instructions 618 can include instructions, which, when executed by computer system 600, can cause computer system 600 to perform methods and/or processes described in this disclosure. Flow-distribution instructions 618 can be executed on at least one of processors 602, forwarding hardware 608, or a combination thereof. Specifically, flow-distribution instructions 618 may include instructions 620 to determine a role for a client device subsequent to detecting a client device via a port of computer system 600. When the client device is detected via the port, the client device is authenticated based on the credentials of the user of the client device. Based on the credentials, a role is associated with the client device. In the example in FIG. 1A, network device 112 can determine a role 162 for client device 122.

Flow-distribution instructions 618 may also include instructions 622 to determine a roaming indicator for the client device, indicating whether the client device is to roam to another network device of the overlay network. In the example in FIG. 1A, network device 112 can determine a roaming indicator, which can indicate “roaming,” for client device 122. Furthermore, flow-distribution instructions 618 may also include instructions 624 to allocate a VLAN to the client device based on the role and the roaming indicator. Referring to the example in FIG. 1A, network device 112 can allocate a roaming VLAN 152 to client device 122 based on its roaming indicator and role 162.

Flow-distribution instructions 618 may include instructions 626 to determine the flow information associated with a data flow from the client device. Here, the flow information indicates a category of the application generating the data flow. Referring to the example in FIG. 1A, network device 112 can determine flow information 192 from data flow 132 from client device 122. Moreover, flow-distribution instructions 618 may include instructions 628 to send, based on a publisher-subscriber messaging protocol (e.g., the MQTT protocol), a message comprising the flow information to a broker of the messaging protocol. In the example in FIG. 1A, network device 112 can send a message 142 comprising flow information 192 to network device 102, which can be the MQTT broker.

Data 630 can include any data that is used as input, or that is generated as output by the methods, operations, communications, and/or processes described in this disclosure. Specifically, data 630 can include a set of application policies, and entries in forwarding hardware (e.g., entries in forwarding hardware 172, 174, and 176 in FIG. 1) based on the application policies. Data 630 can also include flow information obtained from data flows and corresponding termination information.

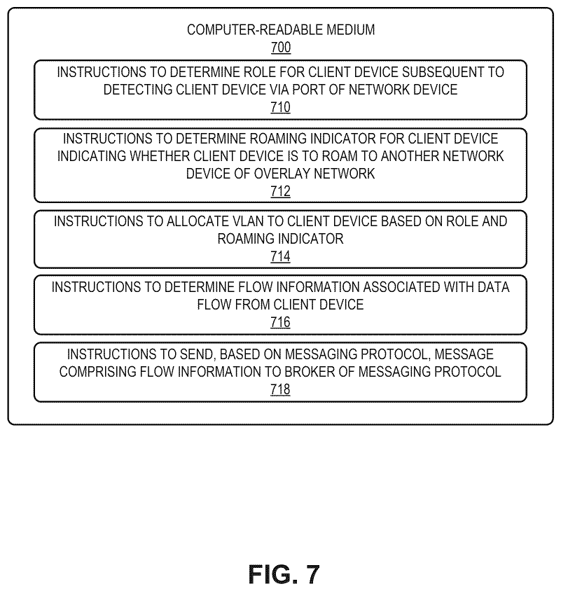

Computer system 600 and flow-distribution instructions 618 may include more instructions than those shown in FIG. 6. For example, flow-distribution instructions 618 can also store instructions for performing DPI on data flow 132 to determine flow information 192 of FIG. 1A; determining application policies for the applications generating data flow 132 of FIG. 1A; determining and publishing the termination information of data flow 136 of FIG. 1B; precluding network device 202 from forwarding flow information published on VLAN 254 to network device 212 of FIG. 2; the operations depicted in the flowcharts of FIGS. 3, 4, and 5; and the instructions of non-transitory CRM 700 in FIG. 7.

FIG. 7 illustrates an example of a CRM facilitating selective synchronization of flow information associated with a data flow in an overlay network using a messaging protocol, in accordance with an aspect of the present application. A CRM 700 can include one or more non-transitory computer-readable mediums or devices storing instructions that, when executed by a computer or processor, cause the computer or processor to perform a method. Therefore, the instructions in CRM 700 can be stored in one or more non-transitory computer-readable mediums or devices. CRM 700 can include instructions 710 to determine a role for a client device subsequent to detecting a client device via a port of a network device. In the example in FIG. 1A, network device 112 can determine a role 162 for client device 122.

CRM 700 can also include instructions 712 to determine a roaming indicator for the client device indicating whether the client device is to roam to another network device of the overlay network. In the example in FIG. 1A, network device 112 can determine a roaming indicator, which can indicate “roaming,” for client device 122. CRM 700 can include instructions 714 to allocate a VLAN to the client device based on the role and the roaming indicator. In the example in FIG. 1A, network device 112 can allocate a roaming VLAN 152 to client device 122 based on its roaming indicator and role 162.

Furthermore, CRM 700 can include instructions 716 to determine the flow information associated with a data flow from the client device. In the example in FIG. 1A, network device 112 can determine flow information 192 from data flow 132 from client device 122. In addition, CRM 700 can include instructions 718 to send, based on a publisher-subscriber messaging protocol, a message comprising the flow information to a broker of the messaging protocol. In the example in FIG. 1A, network device 112 can send a message 142 comprising flow information 192 to network device 102, which can be the MQTT broker.

CRM 700 may include more instructions than those shown in FIG. 7. For example, CRM 700 can also store instructions for performing DPI on data flow 132 to determine flow information 192 of FIG. 1A; determining application policies for the applications generating data flow 132 of FIG. 1A; determining and publishing the termination information of data flow 136 of FIG. 1B; precluding network device 202 from forwarding flow information published on VLAN 254 to network device 212 of FIG. 2; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a network device in an overlay network. During operation, the network device can determine a role for a first client device subsequent to detecting the first client device via a port of the network device. The network device can determine a roaming indicator for a first client device indicating whether the first client device is to roam to another network device of the overlay network. The network device can then allocate a VLAN to the first client device based on the role and the roaming indicator. Subsequently, the network device can determine flow information associated with a first data flow from the first client device. The flow information can indicate a category of a first application generating the first data flow. The network device can send, based on a subscriber-publisher messaging protocol, a first message comprising the flow information to a broker of the messaging protocol. Here, the flow information is to be distributed by the broker to a set of network devices of the overlay network subscribing to receive flow information associated with the VLAN.

In a variation on this aspect, to determine the flow information, the network device can perform DPI on a set of initial packets of the first data flow and determine the category of the first application based on the DPI.

In a further variation, the network device can determine a first application policy corresponding to the first application based on the category and the role. The first application policy can indicate an action to be performed for the first data flow. The network device can then program an entry in the forwarding hardware of the network device with the first application policy and a flow identifier for the first data flow.

In a variation on this aspect, to determine the roaming indicator, the network device can determine whether a type of the first client device supports roaming. If the type of the first client device supports roaming, the network device can determine whether the first client device has previously roamed within a predetermined period.

In a variation on this aspect, the network device can determine that the first data flow from the first client device is terminated. The network device can then send, based on the messaging protocol, a second message to the broker indicating that the first data flow is terminated.

In a variation on this aspect, the messaging protocol comprises a Message Queuing Telemetry Transport (MQTT) protocol.

In a variation on this aspect, the network device can select the broker from a plurality of brokers associated with the overlay network based on the VLAN. Here, a respective broker is associated with a subset of subscribers in the overlay network.

In a variation on this aspect, the network device can subscribe, with the broker, to flow information associated with a respective VLAN configured at the network device based on the messaging protocol. The network device can then receive a third message comprising flow information for a second data flow associated with a second client device coupled to a second network device of the overlay network based on the subscription. Subsequently, the network device can program a second entry in the forwarding hardware with a second application policy for the second data flow. The second application policy can correspond to a category of a second application indicated in the received flow information.

In a further variation, the network device can detect, subsequent to programming the second entry, the second client device from a port of the network device. The network device can then receive the second data flow from the port and forward the second data flow based on the second entry.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
determining, by a network device in an overlay network, a role for a first client device subsequent to detecting the first client device via a port of the network device;
determining, by the network device, a roaming indicator for a first client device indicating whether the first client device is to roam to another network device of the overlay network;
allocating a virtual local area network (VLAN) to the first client device based on the role and the roaming indicator;
determining flow information associated with a first data flow from the first client device, wherein the flow information indicates a category of a first application generating the first data flow; and
sending, based on a subscriber-publisher messaging protocol, a first message comprising the flow information to a broker of the messaging protocol, wherein the flow information is to be distributed by the broker to a set of network devices of the overlay network subscribing to receive flow information associated with the VLAN.

2. The method of claim 1, wherein determining the flow information comprises:
performing deep-packet inspection (DPI) on a set of initial packets of the first data flow; and
determining the category of the first application based on the DPI.

3. The method of claim 2, further comprising:
determining a first application policy corresponding to the first application based on the category and the role, wherein the first application policy indicates an action to be performed for the first data flow; and
programming, by the network device, an entry in forwarding hardware of the network device with the first application policy and a flow identifier for the first data flow.

4. The method of claim 1, wherein determining the roaming indicator comprises:
determining whether a type of the first client device supports roaming; and
in response to determining that the type of the first client device supports roaming, determining whether the first client device has previously roamed within a predetermined period.

5. The method of claim 1, further comprising:
determining that the first data flow from the first client device is terminated; and
sending, based on the messaging protocol, a second message to the broker indicating that the first data flow is terminated.

6. The method of claim 1, wherein the messaging protocol comprises a Message Queuing Telemetry Transport (MQTT) protocol.

7. The method of claim 1, further comprising selecting the broker from a plurality of brokers associated with the overlay network based on the VLAN, wherein a respective broker is associated with a subset of subscribers in the overlay network.

8. The method of claim 1, further comprising:
subscribing, with the broker, to flow information associated with a respective VLAN configured at the network device based on the messaging protocol;
receiving a third message comprising flow information for a second data flow associated with a second client device coupled to a second network device of the overlay network based on the subscription; and
programming, by the network device, a second entry in the forwarding hardware with a second application policy for the second data flow, wherein the second application policy corresponds to a category of a second application indicated in the received flow information.

9. The method of claim 8, further comprising:
detecting, subsequent to programming the second entry, the second client device from a port of the network device;
receiving the second data flow from the port; and
forwarding the second data flow based on the second entry.

10. A non-transitory computer-readable storage medium storing instructions which, when executed by a network device in an overlay network, cause the network device to perform a method, the method comprising:
determining a role for a first client device subsequent to detecting the first client device via a port of the network device;
determining a roaming indicator for a first client device indicating whether the first client device is to roam to another network device of the overlay network;
allocating a virtual local area network (VLAN) to the first client device based on the role and the roaming indicator;
determining flow information associated with a first data flow from the first client device, wherein the flow information indicates a category of a first application generating the first data flow; and
sending, based on a subscriber-publisher messaging protocol, a first message comprising the flow information to a broker of the messaging protocol, wherein the flow information is to be distributed by the broker to a set of network devices of the overlay network subscribing to receive flow information associated with the VLAN.

11. The non-transitory computer-readable storage medium of claim 10, wherein determining the flow information comprises:
performing deep-packet inspection (DPI) on a set of initial packets of the first data flow; and
determining the category of the first application based on the DPI.

12. The non-transitory computer-readable storage medium of claim 11, wherein the method further comprises:
determining a first application policy corresponding to the first application based on the category and the role, wherein the first application policy indicates an action to be performed for the first data flow; and
programming, by the network device, an entry in forwarding hardware of the network device with the first application policy and a flow identifier for the first data flow.

13. The non-transitory computer-readable storage medium of claim 10, wherein determining the roaming indicator comprises:
determining whether a type of the first client device supports roaming; and
in response to determining that the type of the first client device supports roaming, determining whether the first client device has previously roamed within a predetermined period.

14. The non-transitory computer-readable storage medium of claim 10, wherein the method further comprises:
determining that the first data flow from the first client device is terminated; and
sending, based on the messaging protocol, a second message to the broker indicating that the first data flow is terminated.

15. The non-transitory computer-readable storage medium of claim 10, wherein the messaging protocol comprises a Message Queuing Telemetry Transport (MQTT) protocol.

16. The non-transitory computer-readable storage medium of claim 10, wherein the method further comprises selecting the broker from a plurality of brokers associated with the overlay network based on the VLAN, wherein a respective broker is associated with a subset of subscribers in the overlay network.

17. The non-transitory computer-readable storage medium of claim 10, wherein the method further comprises:
subscribing, with the broker, to flow information associated with a respective VLAN configured at the network device based on the messaging protocol;
receiving a third message comprising flow information for a second data flow associated with a second client device coupled to a second network device of the overlay network based on the subscription; and
programming, by the network device, a second entry in the forwarding hardware with a second application policy for the second data flow, wherein the second application policy corresponds to a category of a second application indicated in the received flow information.

18. The non-transitory computer-readable storage medium of claim 17, wherein the method further comprises:
detecting, subsequent to programming the second entry, the second client device from a port of the network device;
receiving the second data flow from the port; and
forwarding the second data flow based on the second entry.

19. A computer system, comprising:
at least one processing resource;
forwarding hardware; and
a non-transitory computer-readable storage medium storing instructions that when executed by the processing resource cause the computer system to:
determine a role for a first client device subsequent to detecting the first client device via a port of the computer system, the computer system being in an overlay network;
determine a roaming indicator for a first client device indicating whether the first client device is to roam to another device of the overlay network;
allocate a virtual local area network (VLAN) to the first client device based on the role and the roaming indicator;
determine flow information associated with a first data flow from the first client device, wherein the flow information indicates a category of a first application generating the first data flow; and
send, based on a subscriber-publisher messaging protocol, a first message comprising the flow information to a broker of the messaging protocol, wherein the flow information is to be distributed by the broker to a set of network devices of the overlay network subscribing to receive flow information associated with the VLAN.

20. The computer system of claim 19, wherein the instructions that when executed by the processing resource cause the computer system further to:
determine that the first data flow from the first client device is terminated; and
send, based on the messaging protocol, a second message to the broker indicating that the first data flow is terminated.
